(19) United States
(12) Patent Application Publication
(10) Pub. No.: US 2008/0002970 A1
(43) Pub. Date: Jan. 3, 2008

(54) Solderable compact camera module and method of manufacture thereof

(75) Inventor: Ching-Wen Cheng, Taipei City (TW)

Correspondence Address: BIRCH STEWART KOLASCH & BIRCH, PO BOX 747, FALLS CHURCH, VA, 22040-0747, US

(73) Assignee: ACME SYSTEM TECHNOLOGIES CORP.

(21) Appl. No.: 11/478,649

(22) Filed: Jul. 3, 2006

(51) Int. Cl. G03D 13/00

(52) U.S. Cl. 396/661

(57) ABSTRACT

A solderable CCM (Compact Camera Module) contains a main board, a CCM base and a lens module. The CCM base is placed on the main board. The lens module is disposed in the CCM base. A thermal insulating gap covers the CCM base to prevent the high temperature of the SMT (Surface Mount Technology) process from affecting the optical properties of the lens module.

### BACKGROUND OF THE INVENTION

1. Field of Invention

The present invention relates to a compact camera module. More particularly, the present invention relates to a solderable compact camera module and manufacture method thereof.

2. Description of Related Art

In marketing 3G (third-generation) services, video telephony has often been used as the flagship 3G killer applications. Every cell phone must be configured with one or two CCM (Compact Camera Module) to implement the video telephony function. Moreover, the webcam also uses the CCM to capture images. In the last few years the application of CCM is very broad and popular.

Because the CCM is very compact, the control circuit is always soldered through SMT (Surface Mount technology). In the SMT process, infrared rays or hot air heating are used to thaw the tin soldering paste then solder the devices. The lead process temperature is between 217° C. to 230° C. The lead free process temperature is between 237° C. to 265° C. On the other hand, all soldered devices must be at high temperatures over 150° C. for 3 to 4 minutes during the SMT process.

The CCM lens is made of polycarbonate or optical plastic material. The polycarbonate or optical plastic material are low cost, but the heat-resistant temperature is between 80° C. to 120° C. The high temperature of the SMT process can influence the optical properties of the lens.

Therefore, after the control circuit has finished the SMT process, the lens module and the control circuit can be assembled together and become the CCM. The common CCM assemblage types are flexible printed circuit board type, board to board type, and socket type.

The main drawback of conventional CCMs is that they need space and other devices to assemble the lens module and the control circuit. Such as the flexible printed circuit board type, besides the lens module and the control circuit, the CCM also needs the flexible printed circuit board and the connectors to transmit the signal between the lens and control circuit. It takes space and increases cost. Furthermore, to ensure the quality of the products, after the control circuit has finished the SMT process and the CCM finished the assembly process, all devices needs inspecting. The inextricable inspections reduce the production efficiency.

Therefore, it is desirable to improve the CCM module into a more compact form and modify the method of manufacture to reduce the cost, and increase the production efficiency.

### SUMMARY OF THE INVENTION

The present invention provides a solderable CCM to more compact, and method of manufacture thereof to reduce the cost and increase the production efficiency.

The solderable CCM contains a CCM base, a lens module, a thermal insulating cap. The lens module is installed in the CCM base. The thermal insulating cap is covered on the CCM base to prevent high temperatures affecting the lens module optical property.

The method for the solderable CCM manufacturing comprises: providing a CCM base, installing a lens module in the CCM base, covering a thermal insulating cap on the CCM base, and into the SMT process.

The solderable CCM lens module and control circuit are assembled together before the SMT process. The present invention can therefore reduce the cost of the CCM, increase the production efficiency, and makes the solderable CCM more compact.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention becomes better understood with regard to the following description, appended claims, and accompanying drawings where:

The invention can be more fully understood by reading the following detailed description of the preferred embodiment, with reference made to the accompanying drawings as follows:

FIG. 1 is schematic diagram of a solderable CCM structure.

FIG. 2 is a schematic diagram along the line I-II of FIG. 1 cross-sectional view of a solderable CCM structure.

FIG. 3A to FIG. 3F are schematic diagrams are the manufacturing steps of a solderable CCM, wherein all cross-sectional views of a solderable CCM structure are along the line I-II of FIG. 1.

### DESCRIPTION OF THE PREFERRED EMBODIMENTS

Reference is now be made in detail to the present preferred embodiments of the invention, examples of which are illustrated in the accompanying drawings. Wherever possible, the same reference numbers are used in the drawings and the description to refer to the same or like parts.

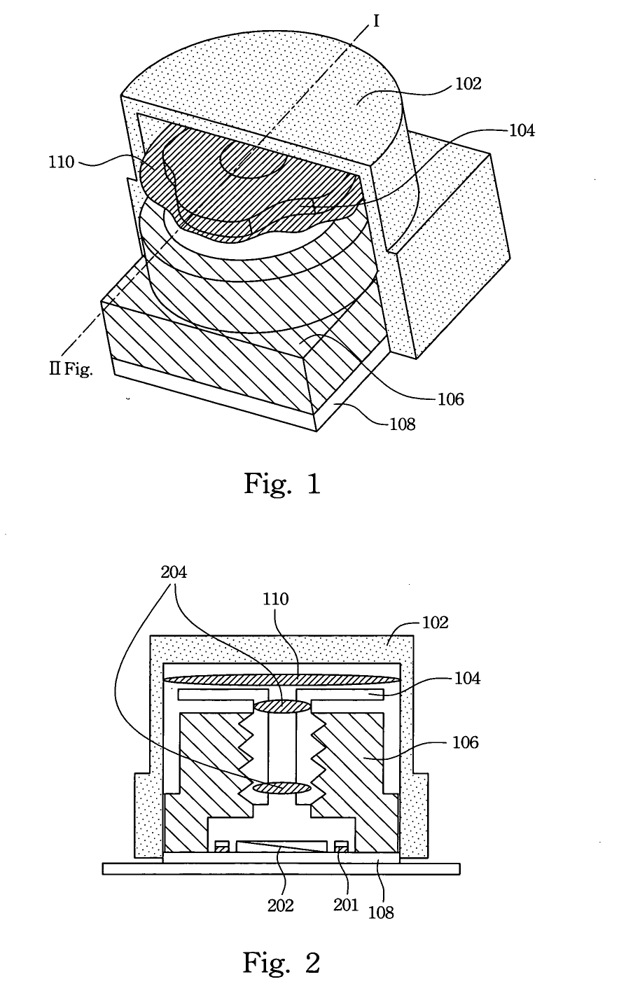

Please refer to FIG. 1 and FIG. 2. FIG. 1 is schematic diagram of a solderable CCM structure. FIG. 2 is a schematic diagram along the line I-II of FIG. 1 cross-sectional view of a solderable CCM structure. The solderable CCM contains a main board 108, a lens module 104, a CCM base 106, a polyester film 110, and a thermal insulating cap 102. The lens module 104 is installed in the CCM base 106. The polyester film 110 and thermal insulating cap 102 are covered on the lens module 104. In the FIG. 2, a control circuit 201 and an image sensor 202 are configured on the main board 108. The lens module 104 further comprises lenses 204.

In this embodiment the thermal insulating cap is used to isolate the SMT process temperature to lower than the heat-resistant temperature of the lens module. The SMC soldering stove exceeds 200° C. and solders the devices over 3 minutes. But the lenses 204 are polycarbonate or optical plastic materials. The heat-resistant temperatures of polycarbonate or optical plastic materials are only between 80° C. to 120° C. Therefore a thermal insulating cap covers the lens module 106 to prevent the high temperature SMT process from affecting the optical properties of the lens module 106.

The thermal insulating cap 102 is made from material with low thermal conductivity and high heat-resistance. The thermal insulating cap 102 is heat-resistant to temperatures over 300° C., higher than the SMT process temperature. The thermal insulating cap 102 has low thermal conductivity. The area covered by the thermal insulating cap 102 remains below 80° C. during the 3 minutes of the SMT process. For this reason, the lens module 104 can be included in the SMT process when the lens is covered with the thermal insulating cap 102.

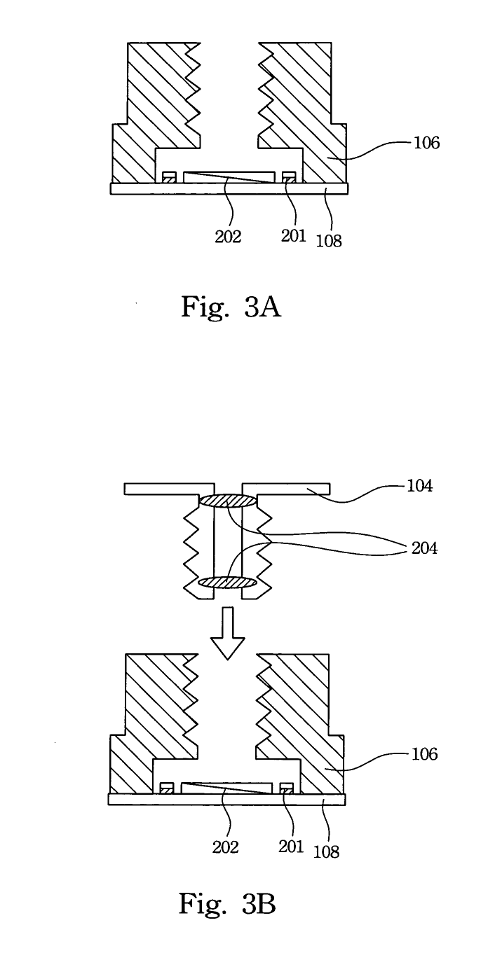

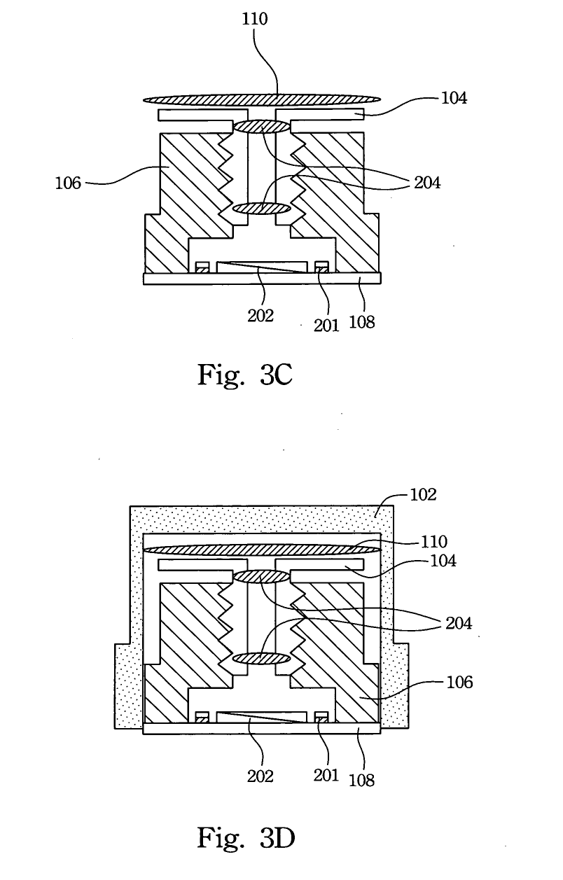

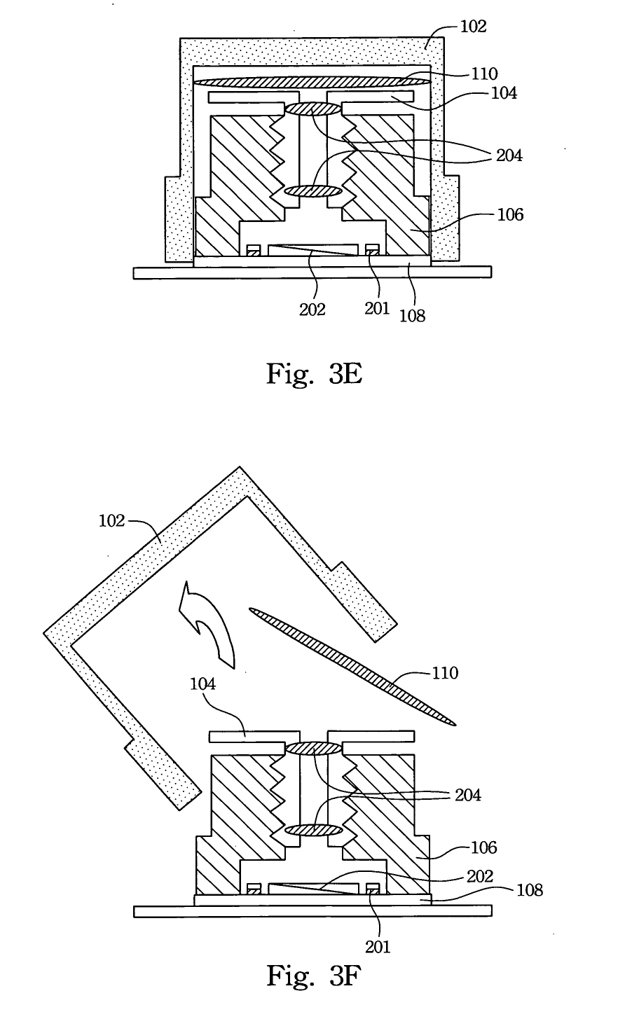

FIG. 3A to FIG. 3F are schematic diagrams showing the manufacturing steps of a solderable CCM, wherein all cross-sectional views of a solderable CCM structure are along the line I-II in FIG. 1. Referring to FIG. 3A, the CCM base 106 is a liquid crystal polymer material with a heat-resistant temperature over 300° C. The main board 108 is placed below the CCM base 106. The image sensor 202 and the control circuit 201 are configured on the main board 108.

In FIG. 3B, the lens module 104 is installed in the CCM base 106. In this embodiment the lens module 104 is screwed in the CCM base 106 to increase the assembly efficiency. Moreover, before assembling the lens module 104 and the CCM base 106, the lens module 104 parameters can be fine tuned for getting the best image. The lens module 104 further comprises the lenses 204. The lenses 204 are polycarbonate or optical plastic materials.

After the CCM is assembled, FIG. 3C shows a polyester film 110 covering the lens module 104. The polyester film 110 is used to protect the lens module 104. The polyester film 110 prevents particles and dust from penetrating the lens module 104.

In FIG. 3D a thermal insulating cap 102 covers the CCM base 106. The thermal insulating cap 102 is made of heat-resistant material resistant to temperature of over 300° C. The thermal insulating cap 102 has low thermal conductivity properties. The lens module 104 covered by the thermal insulating cap 102 therefore remains below 80° C. during the 3 minutes of the SMT process.

In FIG. 3E, the solderable CCM is placed into the SMT process. Since the SMT process and steps thereof are known in the art, they are not further described herein. After the SMT process, FIG. 3F shows the removal of the thermal insulating cap 102 and polyester film 110 so a sampling inspection can be carried out. The thermal insulating cap 102 and polyester film 110 can also be used as protection to prevent damage during the transportation process and save the cost of a dust guard.

Because of the effect of the thermal insulating cap, the lens module and control circuit are assembled before the SMT process. The solderable CCM does not use the connectors to connect the lens module and the control circuit.

So the solderable CCM is more compact and the cost of the CCM is also reduced. The sampling inspection only occurs after the SMT process. Production efficiency is increased.

It is apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A manufacturing method for a solderable compact camera module, comprising:
providing a compact camera module base and a main board;
installing a lens module in the compact camera module base;
covering a thermal insulating cap on the compact camera module base; and
proceeding surface mounting technology processes.

2. The method of claim 1, wherein the compact camera module base is a liquid crystal polymer material.

3. The method of claim 1, wherein installing the lens module on the compact camera module base further comprises:
fine tuning the lens module parameters.

4. The method of claim 1, wherein the lens module comprises at least one lens.

5. The method of claim 4, wherein the material of the lens is polycarbonate material.

6. The method of claim 4, wherein the material of the lens is optical plastic.

7. The method of claim 1, wherein installing the lens module on the compact camera module base further comprises:
covering a polyester film on the lens module.

8. The method of claim 1, wherein the thermal insulating cap is made of a heat-resistant material.

9. The method of claim 1, wherein the thermal insulating cap is capable of isolating the surface mounting technology process temperature to lower than the lens module heat-resistant temperature.

10. The method of claim 1, wherein the thermal insulating cap heat-resistant temperature is higher than the surface mounting technology process temperature.

11. A solderable compact camera module comprising:
a main board;
a compact camera module base placed on the main board;
a lens module installed in the compact camera module base; and
a thermal insulating cap covered on the compact camera module base.

12. The solderable compact camera module of claim 11, wherein the solderable compact camera module further comprises:
a image sensor; and
a control circuit;
wherein the image sensor and the control circuit are configured on the main board.

13. The solderable compact camera module of claim 11, wherein the material of the compact camera module is liquid crystal polymer.

14. The solderable compact camera module of claim 11, wherein the lens module comprises at least one lens.

15. The solderable compact camera module of claim 14, wherein the material of the lens is polycarbonate.

16. The solderable compact camera module of claim 14, wherein the material of the lens is optical plastic.

17. The solderable compact camera module of claim 11, wherein the solderable compact camera module further comprises:
a polyester film covered on the lens module.

18. The solderable compact camera module of claim 11, wherein the thermal insulating cap is made of a heat-resistant material.

19. The solderable compact camera module of claim 11, wherein the thermal insulating cap is capable of isolating the surface mounting technology process temperature to lower than the lens module heat-resistant temperature.

20. The solderable compact camera module of claim 11, wherein the thermal insulating cap heat-resistant temperature is higher than the surface mounting technology process temperature.
